(19) United States
(12) Patent Application Publication
(10) Pub. No.: US 2004/0023176 A1
(43) Pub. Date: Feb. 5, 2004

(54) Fluorinated polymer

(76) Inventors: Yuji Harada, Niigata-ken (JP); Jun Hatakeyama, Niigata-ken (JP); Yoshio Kawai, Niigata-ken (JP); Michitaka Ootani, Tokyo (JP); Haruhiko Komoriya, Kawagoe-shi (JP); Kazuhiko Maeda, Tokyo (JP)

Correspondence Address: BIRCH STEWART KOLASCH & BIRCH, PO BOX 747, FALLS CHURCH, VA, 22040-0747, US

(21) Appl. No.: 10/629,785

(22) Filed: Jul. 30, 2003

(30) Foreign Application Priority Data
Jul. 31, 2002 (JP) 2002-222955

(51) Int. Cl. C08F 112/00

(52) U.S. Cl. 430/907; 524/805; 526/242; 526/250

(57) ABSTRACT

ABSTRACT A fluorinated polymer having a polydispersity index (Mw/Mn) of 1-1.20 can be prepared by subjecting an aromatic monomer having trifluoromethyl groups and acid labile groups to living anion polymerization. The fluorinated polymer is suitable for use in chemically amplified resist compositions having sensitivity to ultraviolet radiation.

This invention relates to fluorinated polymers having an appropriate polydispersity index for use in chemically amplified resist compositions for forming fine-circuitry patterns on the surface of semiconductor devices using ultraviolet or vacuum ultraviolet radiation.

### BACKGROUND OF THE INVENTION

In the drive for higher integration and operating speeds in LSI devices, the pattern rule is made drastically finer. The rapid advance toward finer pattern rules is grounded on the development of a projection lens with an increased NA, a resist material with improved performance, and exposure light of a shorter wavelength. To the demand for a resist material with a higher resolution and sensitivity, positive resist materials of the chemical amplification type utilizing as a catalyst an acid generated upon light exposure are effective as disclosed in U.S. Pat. No. 4,491,628 and U.S. Pat. No. 5,310,619 (JP-B 2-27660 and JP-A 63-27829). They now become predominant resist materials especially adapted for deep UV lithography.

The change-over from i-line (365 nm) to shorter wavelength KrF excimer laser (248 nm) brought about a significant innovation. Resist materials adapted for KrF excimer lasers enjoyed early use on the 0.30 micron process, passed through the 0.25 micron rule, and currently entered the mass production phase on the 0.18 micron rule. Engineers have started investigation on the 0.10 micron rule or below, with the trend toward a finer pattern rule being accelerated.

ArF excimer laser (193 nm) is expected to enable miniaturization of the design rule to 0.13 μm or less. Since conventionally used novolac resins and polyvinylphenol resins have very strong absorption in proximity to 193 nm, they cannot be used as the base resin for resists. To ensure transparency and dry etching resistance, some engineers investigated acrylic and alicyclic (typically cycloolefin) resins as disclosed in JP-A 9-73173, JP-A 10-10739, JP-A 9-230595 and WO 97/33198.

With respect to F₂ laser (157 nm) which is expected to enable further miniaturization to 0.10 μm or less, more difficulty arises in insuring transparency because it was found that acrylic resins, which serve as the base polymer for ArF, are not transmissive to light at all and those cycloolefin resins having carbonyl bonds have strong absorption. It was also found that polyvinylphenol used as the base polymer for KrF excimer laser has a window for absorption in proximity to 160 nm, so the transmittance is somewhat improved, but far below the practical level.

For the preparation of polymers for use in the UV and vacuum UV wavelength regions, many processes utilizing radical polymerization and vinyl addition polymerization have been reported. The polymers obtained by these processes have a wide molecular weight distribution or polydispersity index. When such a polymer is used in resist, a low molecular weight fraction of the polymer gasifies during vacuum steps in the wafer processing process to give rise to problems including a loss of vacuum and contamination of the process atmosphere, and the dissolution rate of the polymer undesirably varies owing to an uneven molecular weight distribution. As a result, the patterning process is reproducible with difficulty, often forming uneven patterns.

### SUMMARY OF THE INVENTION

An object of the invention is to provide a novel polymer having a high transmittance to ultraviolet radiation, especially KrF excimer laser beam (248 nm) and F₂ laser beam (157 nm), a high sensitivity and high etching resistance.

Continuing research works to develop a fluorinated polymer suitable for use in resist compositions, especially positive resist compositions having sensitivity to ultraviolet radiation, especially KrF or F₂ laser beam and improved other properties, we have found that a fluorinated polymer having a polydispersity index (Mw/Mn) in a narrow range of about 1 to about 1.20 can be prepared by subjecting an aromatic monomer having a sufficient fluorine content to living anion polymerization rather than conventional radical polymerization and cationic polymerization.

The present invention provides a fluorinated polymer obtained by living anion polymerization of a monomer having the general formula (1):

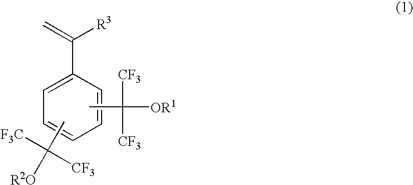

wherein R¹ and R² each are an acid labile group and R³ is hydrogen or methyl, and having a polydispersity index of 1 to 1.20.

In a preferred embodiment, the monomer has the general formula (2):

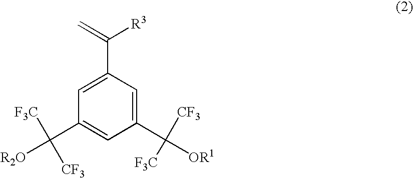

wherein R¹, R² and R³ are as defined above.

### DESCRIPTION OF THE PREFERRED EMBODIMENTS

The fluorinated polymer or high-molecular-weight compound of the invention is obtained by living anion polymerization of a monomer having the general formula (1), preferably formula (2).

In formulae (1) and (2), R¹ and R² may represent the same or different acid labile groups and be used in any desired combination. Preferred are acid labile groups which do not affect living anion polymerization and are compliant with the purpose that some or all of the acid labile groups are to be eliminated after polymerization.

In the invention, the acid labile groups represented by R¹ and R² are preferably selected from the groups of the following formulae (3) to (5).

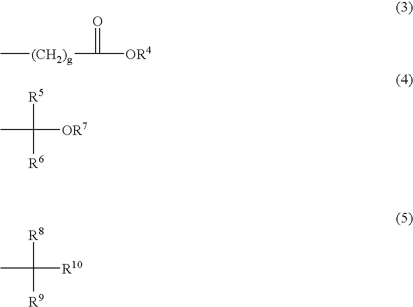

In formula (3), R⁴ is a tertiary alkyl group of 4 to 20 carbon atoms, preferably 4 to 15 carbon atoms, an oxoalkyl group of 4 to 20 carbon atoms or a group of formula (5). Exemplary tertiary alkyl groups are tert-butyl, tert-amyl, 1,1-diethylpropyl, 1-ethylcyclopentyl 1-butylcyclopentyl, 1-thylcyclohexyl, 1-butylcyclohexyl, 1-ethyl-2-cyclopentenyl, 1-ethyl-2-cyclohexenyl, and 2-methyl-2-adamantyl. Exemplary oxoalkyl groups are 3-oxocyclohexyl, 4-methyl-2-oxooxan-4-yl, and 5-methyl-5-oxooxolan-4-yl. Letter g is an integer of 0 to 6.

Illustrative examples of the acid labile groups of formula (3) include tert-butoxycarbonyl, tert-utoxycarbonylmethyl, tert-amyloxycarbonyl, tert-myloxycarbonylmethyl, 1,1-diethylpropyloxycarbonyl, 1,1-diethylpropyloxycarbonylmethyl, 1-ethylcyclopentyloxycarbonyl, 1-ethylcyclopentyloxycarbonylmethyl, 1-ethyl-2-cyclopentenyloxycarbonyl, 1-ethyl-2-cyclopentenyloxycarbonylmethyl, 1-ethoxyethoxycarbonylmethyl, 2-tetrahydropyranyloxycarbonylmethyl, and 2-tetrahydrofuranyloxycarbonylmethyl.

In formula (4), R⁵ and R⁶ are independently hydrogen or straight, branched or cyclic alkyl groups of 1 to 18 carbon atoms, preferably 1 to 10 carbon atoms, for example, methyl, ethyl, propyl, isopropyl, n-butyl, sec-butyl, tert-butyl, cyclopentyl, cyclohexyl, 2-ethylhexyl and n-octyl. R⁷ is a monovalent hydrocarbon group of 1 to 18 carbon atoms, preferably 1 to 10 carbon atoms, which may have a hetero atom (e.g., oxygen atom), for example, straight, branched or cyclic alkyl groups, and such groups in which some hydrogen atoms are replaced by hydroxyl, alkoxy, oxo, amino or alkylamino groups. Illustrative examples of the substituted alkyl groups are given below.

—(CH₂)₄—OH —(CH₂)₈—OH

—(CH₂)₂—O—(CH₂)₃CH₃ —(CH₂)₂—O—(CH₂)₂ OH

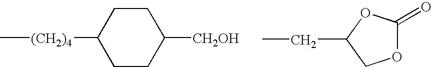

A pair of R⁵ and R⁶, a pair of R⁵ and R⁷, or a pair of R⁶ and R⁷, taken together, may form a ring. Each of R⁵, R⁶ and R⁷ is a straight or branched alkylene group of 1 to 18 carbon atoms, preferably 1 to 10 carbon atoms, when they form a ring.

Of the acid labile groups of formula (4), illustrative examples of the straight or branched groups are given below.

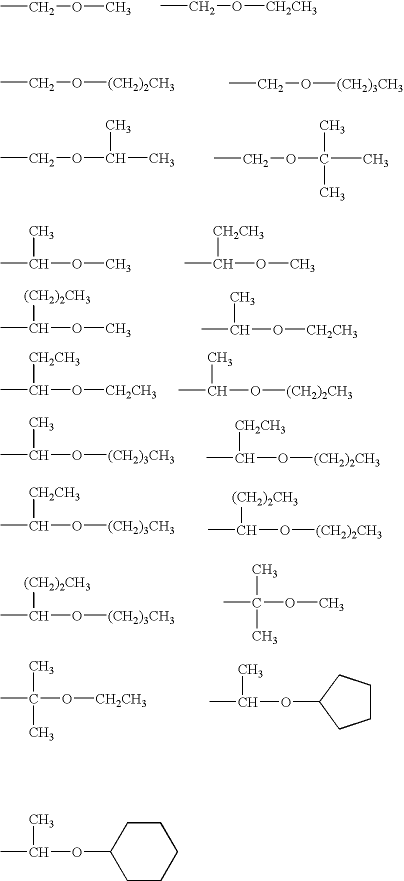

Of the acid labile groups of formula (4), illustrative examples of the cyclic groups include tetrahydrofuran-2-yl, 2-methyltetrahydrofuran-2-yl, tetrahydropyran-2-yl and 2-methyltetrahydropyran-2-yl. Preferred among the groups of formula (4) are ethoxyethyl, butoxyethyl and ethoxypropyl.

In formula (5), R⁸, R⁹ and R¹⁰ are independently monovalent hydrocarbon groups, for example, straight, branched or cyclic alkyl groups of 1 to 20 carbon atoms, which may contain a hetero atom such as oxygen, sulfur, nitrogen or fluorine. A pair of R⁸ and R⁹, a pair of R⁸ and R¹⁰, or a pair of R⁹ and R¹⁰, taken together, may form a ring with the carbon atom to which they are bonded.

Examples of the tertiary alkyl group represented by formula (5) include tert-butyl, triethylcarbyl, 1-ethylnorbornyl, 1-methylcyclohexyl, 1-ethylcyclopentyl, 2-(2-methyl)adamantyl, 2-(2-ethyl)adamantyl, tert-amyl, 1,1,1,3,3,3-hexafluoro-2-methyl-isopropyl, and 1,1,1,3,3,3-hexafluoro-2-cyclohexyl-isopropyl. Other illustrative examples of the tertiary alkyl group are given below.

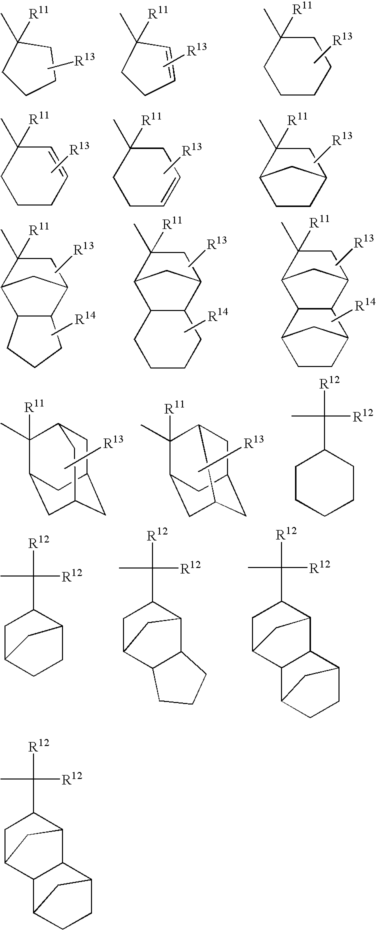

Herein, R¹¹ is a straight, branched or cyclic alkyl group of 1 to 6 carbon atoms, for example, methyl, ethyl, propyl, isopropyl, n-butyl, sec-butyl, n-pentyl, n-hexyl, cyclopropyl, cyclopropylmethyl, cyclobutyl, cyclopentyl and cyclohexyl. R¹² is a straight, branched or cyclic alkyl group of 2 to 6 carbon atoms, for example, ethyl, propyl, isopropyl, n-butyl, sec-butyl, n-pentyl, n-hexyl, cyclopropyl, cyclopropylmethyl, cyclobutyl, cyclopentyl and cyclohexyl. R¹³ and R¹⁴ each are hydrogen or a monovalent hydrocarbon group of 1 to 6 carbon atoms which may contain a hetero atom or a monovalent hydrocarbon group of 1 to 6 carbon atoms which may be separated by a hetero atom. The hydrocarbon groups may be straight, branched or cyclic. The hetero atom is an oxygen, sulfur or nitrogen atom, which is contained or intervenes in the form of —OH, —OR¹⁵, —O—, —S—, —S(═O)—, —NH₂, —NHR¹⁵, —N(R¹⁵)₂, —NH—, or —NR¹⁵— wherein R¹⁵ is an alkyl group of 1 to 5 carbon atoms. Illustrative examples of R¹³ and R¹⁴ include methyl, hydroxymethyl, ethyl, hydroxyethyl, propyl, isopropyl, n-butyl, sec-butyl, n-pentyl, n-hexyl, methoxy, methoxymethoxy, ethoxy and tert-butoxy.

Other useful acid labile groups are trialkylsilyl groups whose alkyl groups each have 1 to 6 carbon atoms. Exemplary trialkylsilyl groups are trimethylsilyl, triethylsilyl and dimethyl-tert-butylsilyl.

As long as the monomer of formula (1) or (2) is used as the main component, another styrene monomer may be copolymerized in the invention.

In order for living polymerization of the above monomers to take place, polymerization initiators are often used, preferably organometallic compounds. Exemplary organometallic compounds are organic alkali metal compounds including n-butyl lithium, sec-butyl lithium, tert-butyl lithium, sodium naphthalene, sodium anthracene, α-methylstyrene tetramer disodium, cumyl potassium, cumyl cesium, phenyl magnesium bromide, phenyl magnesium chloride, ethyl magnesium bromide, ethyl magnesium chloride, n-butyl magnesium bromide, and n-butyl magnesium chloride.

Living polymerization of the above monomers is generally effected in an organic solvent. Examples of suitable organic solvents include cyclic ethers, aromatic hydrocarbons and aliphatic hydrocarbons, such as benzene, toluene, tetrahydrofuran, dioxane, tetrahydropyran, dimethoxyethane, n-hexane, and cyclohexane. These organic solvents may be used alone or in admixture.

For living polymerization of the monomer of formula (1), optimum reaction conditions including the type of living polymerization initiator and the concentration of the monomer in an organic solvent vary with a particular functional group selected for the monomer. It is recommended that the optimum reaction conditions be determined by carrying out a preliminary experiment. In general, the concentration of the monomer in an organic solvent is preferably 1 to 50% by weight, more preferably 5 to 30% by weight.

Polymerization of the monomer of formula (1) or (2) can be carried out by evacuating the reaction system and agitating a solution of the monomer in an organic solvent in vacuum or in a replacement atmosphere of inert gas such as nitrogen. The reaction temperature may be selected in the range of −100° C. to the boiling point. For instance, the preferred reaction temperature is −100° C. when tetrahydrofuran is used as the solvent, and room temperature when benzene is used. If anions at ends of polymerization are unstable enough to retard polymerization at an initial stage of polymerization, a small amount of a polymerizable compound capable of enhancing the stability of anions, for example, styrene or t-butoxystyrene may be added simultaneously with a catalyst and thereafter, the monomer of formula (1) or (2) be added for polymerization. In this event, one end of the polymer being formed is composed of recurring units of styrene or t-butoxystyrene. Near the end of derivative polymerization, the reaction can be terminated by adding a stopper such as methanol, water or methyl bromide to the reaction solution. Further, if necessary, the fluorinated polymer may be worked up and isolated by adding methanol to the reaction mixture for causing the fluorinated polymer to precipitate, followed by washing and drying. The reaction solution generally contains unreacted reactants and by-products as impurities. If the fluorinated polymer produced is used as the base in resist materials for VLSI microfabrication without further treatment, the impurities can have detrimental effects on the wafer processing process. For this reason, sufficient treatment to remove a low molecular fraction and impurities should preferably be carried out.

The fluorinated polymer thus obtained is monodisperse or has a polydispersity index (Mw/Mn) of 1 to 1.20, satisfying the desired narrow molecular weight distribution. With a polydispersity index of more than 1.20, the effect of living polymerization is lessened, allowing a low molecular weight fraction to incur an unstable state during the patterning process. The term “polydispersity index” used herein represents the breadth of molecular weight distribution and is determined as Mw/Mn wherein Mw is a weight average molecular weight and Mn is a number average molecular weight.

The yield of polymerization is approximately 100% based on the monomer fed to the reaction system. The molecular weight of the polymer is readily calculated from the weight of the monomer used and the number of moles (molecular weight) of the polymerization initiator. The number average molecular weight (Mn) is determined from the measurement of a membrane osmometer. By further performing characterization by gel permeation chromatography (GPC), it can be evaluated whether the fluorinated polymer has the desired polydispersity index.

The fluorinated polymer of the invention is useful as a base polymer in chemically amplified photoresist compositions whose formulation is not critical. In one exemplary resist composition, there are formulated the fluorinated polymer of the invention as a base, an onium salt cationic photoinitiator, an inert organic solvent, a quencher and optional components. The onium salt cationic photoinitiator is to generate a strong acid upon exposure to light. When a resist film comprising the fluorinated polymer of the invention and the onium salt is processed by a wafer stepper, the onium salt is decomposed to generate a strong acid which causes the acid labile groups in the fluorinated polymer to be cleaved whereby the fluorinated polymer turns to be alkali soluble. The amount of the onium salt cationic photoinitiator blended is preferably 0.01 to 20%, more preferably 1 to 10% by weight of the entire resist composition.

On use, the resist composition is generally dissolved in a several fold volume of an organic solvent to form a resist solution which is ready to apply. The suitable organic solvent is the one in which the resist components including the living polymer of the invention are fully soluble and which allows a resist coating to spread uniformly. Illustrative, non-limiting, examples of the organic solvent include ketones such as cyclohexanone and methyl-2-n-amylketone; alcohols such as 3-methoxybutanol, 3-methyl-3-methoxybutanol, 1-methoxy-2-propanol, and 1-ethoxy-2-propanol; ethers such as propylene glycol monomethyl ether, ethylene glycol monomethyl ether, propylene glycol monoethyl ether, ethylene glycol monoethyl ether, propylene glycol dimethyl ether, and diethylene glycol dimethyl ether; and esters such as propylene glycol monomethyl ether acetate, propylene glycol monoethyl ether acetate, ethyl lactate, ethyl pyruvate, butyl acetate, methyl 3-methoxypropionate, ethyl 3-ethoxypropionate, tert-butyl acetate, tert-butyl propionate, and propylene glycol mono-tert-butyl ether acetate. The solvent is preferably used in an amount of about 200 to 5,000 parts by weight per 100 parts by weight of the resin.

Preferred quenchers used herein include ammonia, primary, secondary and tertiary aliphatic amines, mixed amines, aromatic amines, heterocyclic amines, carboxyl group-bearing nitrogenous compounds, sulfonyl group-bearing nitrogenous compounds, hydroxyl group-bearing nitrogenous compounds, hydroxyphenyl group-bearing nitrogenous compounds, alcoholic nitrogenous compounds, amide derivatives, and imide derivatives. The quencher is preferably used in an amount of about 0.01 to 2 parts by weight, more preferably 0.01 to 1 part by weight per 100 parts by weight of the resin. Less than 0.01 part of the quencher is ineffective to its purpose whereas more than 2 parts of the quencher may lower the sensitivity of the resist composition.

For the use, light exposure and processing of the resist composition, well-known lithographic techniques may be employed. By way of light exposure through a photomask using a stepper or scanner, the resist composition can be processed into fine patterns which are suitable in a wide range of applications including semiconductor devices and displays. For development, conventional positive developers may be used.

The fluorinated polymers of the invention are suited as a base polymer in resist compositions to be exposed to ultraviolet radiation of 157 nm to 254 nm, especially suited for micropatterning in the advanced semiconductor technology. The polymers can also comply with the lithography using electron beams and x-rays.

### EXAMPLE

Examples of the invention are given below by way of illustration and not by way of limitation.

### Example 1

A monomer, 3,5-di[2-t-butoxy-2,2-bistrifluoromethyl]methyl-styrene was previously treated with CaH₂ to remove water and impurities, then purified by using benzophenone sodium and distillation. A 1-liter flask was charged with 600 ml of tetrahydrofuran as a solvent and 3.5×10⁻³ mol of sec-butyl lithium as a polymerization initiator. To this mixture, 36 g of the purified 3,5-di[2-t-butoxy-2,2-bistrifluoromethyl]methyl-styrene diluted with 100 ml of tetrahydofuran at −78° C. was added. Polymerization reaction was conducted for 1 hour whereupon the solution turned red. Methanol was added to the reaction solution to terminate polymerization. The reaction solution was poured into methanol whereupon the polymer precipitated. The precipitate was separated, worked up and dried, yielding 36 g of a white polymer.

The polymer had a number average molecular weight (Mn) of 1.1×10⁴/mole as determined by GPC using polystyrene standards. The polydispersity index (Mw/Mn) was 1.17. This is designated Polymer 1.

### Example 2

A monomer, 3,5-di[2-t-butoxy-2,2-bistrifluoromethyl]-methyl-α-methylstyrene was previously treated with CaH₂ to remove water and impurities, then purified by using benzophenone sodium and distillation. A 1-liter flask was charged with 600 ml of tetrahydrofuran as a solvent and 3.5×10⁻³ mol of sec-butyl lithium as a polymerization initiator. To this mixture, 37 g of the purified 3,5-di[2-t-butoxy-2,2-bistrifluoromethyl]methyl-α-methylstyrene diluted with 100 ml of tetrahydofuran at −78° C. was added. Polymerization reaction was conducted for 1 hour whereupon the solution turned red. Methanol was added to the reaction solution to terminate polymerization. The reaction solution was poured into methanol whereupon the polymer precipitated. The precipitate was separated, worked up and dried, yielding 37 g of a white polymer.

The polymer had a number average molecular weight (Mn) of 1.13×10⁴/mole as determined by GPC using polystyrene standards. The polydispersity index (Mw/Mn) was 1.07. This is designated Polymer 2.

### Example 3

Monomers, 3,5-di[2-ethoxyethoxy-2,2-bistrifluoromethyl]methyl-styrene and 3,5-di[2-t-butoxy-2,2-bistrifluoromethyl]methyl-styrene each were previously treated with CaH₂ to remove water and impurities, then purified by using benzophenone sodium and distillation. A 1-liter flask was charged with 600 ml of tetrahydrofuran as a solvent and 3.5×10⁻³ mol of sec-butyl lithium as a polymerization initiator. To this mixture, 19 g of the purified 3,5-di[2-ethoxyethoxy-2,2-bistrifluoromethyl]methylstyrene and 18 g of the purified 3,5-di[2-t-butoxy-2,2-bistrifluoromethyl]methyl-styrene diluted with 100 ml of tetrahydofuran at −78° C. was added. Polymerization reaction was conducted for 1 hour whereupon the solution turned red. Methanol was added to the reaction solution to terminate polymerization. The reaction solution was poured into methanol whereupon the polymer precipitated. The precipitate was separated, worked up and dried, yielding 36 g of a white polymer.

The polymer had a number average molecular weight (Mn) of 1.2×10⁴/mole as determined by GPC using polystyrene standards. The polydispersity index (Mw/Mn) was 1.15. This is designated Polymer 3.

### Example 4

In 1000 ml of acetone was dissolved 30 g of Polymer 1. A small amount of conc. hydrochloric acid was added to the solution, which was stirred for 7 hours at 20° C. The reaction solution was poured into water whereupon the polymer precipitated. The precipitate was washed and dried, yielding 23 g of the polymer. On analysis by GPC and proton-NMR where the peak attributable to t-butoxy group was not observed, the polymer was identified to be poly-3,5-di[2-hydroxy-2,2-bistrifluoromethyl]methyl-styrene having a number average molecular weight (Mn) of 8800 and a polydispersity index (Mw/Mn) of 1.17.

In 200 ml of pyridine was dissolved 20 g of the above polymer. With stirring at 45° C., 13.0 g of di-tert-butyl dicarbonate was added. Reaction was effected for one hour, after which the reaction solution was added dropwise to 3 liters of water, yielding a white solid. After filtration, the solid was dissolved in 100 ml of acetone, which was added dropwise to 5 liters of water. Filtration and vacuum drying yielded a polymer. On analysis by proton-NMR, it was found that 48% of the hydrogen atoms of hydroxyl groups on 3,5-di[2-hydroxy-2,2-bistrifluoromethyl]methyl-styrene had been replaced by t-butoxycarbonyl groups. The polymer had a number average molecular weight (Mn) of 1.22×10⁴/mole as determined by GPC using polystyrene standards. The polydispersity index (Mw/Mn) was 1.17. This is designated Polymer 4.

### Example 5

In 1000 ml of acetone was dissolved 30 g of Polymer 2. A small amount of conc. hydrochloric acid was added to the solution, which was stirred for 7 hours at 20° C. The reaction solution was poured into water whereupon the polymer precipitated. The precipitate was washed and dried, yielding 24 g of the polymer. On analysis by GPC and proton-NMR where the peak attributable to t-butoxy group was not observed, the polymer was identified to be poly-3,5-di[2-hydroxy-2,2-bistrifluoromethyl]methyl-α-methylstyrene having a Mw of 8800 and a Mw/Mn of 1.17.

In 200 ml of pyridine was dissolved 20 g of the above polymer. With stirring at 45° C., 13.0 g of di-tert-butyl dicarbonate was added. Reaction was effected for one hour, after which the reaction solution was added dropwise to 3 liters of water, yielding a white solid. After filtration, the solid was dissolved in 100 ml of acetone, which was added dropwise to 5 liters of water. Filtration and vacuum drying yielded a polymer. On analysis by proton-NMR, it was found that 40% of the hydrogen atoms of hydroxyl groups on 3,5-di[2-hydroxy-2,2-bistrifluoromethyl]methyl-α-methylstyrene had been replaced by t-butoxycarbonyl groups. The polymer had a number average molecular weight (Mn) of 1.23×10⁴/mole as determined by GPC using polystyrene standards. The polydispersity index (Mw/Mn) was 1.07. This is designated Polymer 5.

### Example 6

In 1000 ml of acetone was dissolved 30 g of Polymer 3. Then 5 g of oxalic acid and 10 g of water was added to the solution, which was stirred for 20 hours at 40° C. The reaction solution was poured into water whereupon the polymer precipitated. The precipitate was washed and dried, yielding 26 g of the polymer. On analysis by GPC and proton-NMR, the peak attributable to ethoxyethoxy group was not observed. The polymer was identified to be poly-3,5-di[2-t-butoxy-2,2-bistrifluoromethyl]methyl-styrene-co-3,5-di[2-hydroxy-2,2-bistrifluoromethyl]methyl-styrene in a ratio of 0.52:0.48 having a number average molecular weight (Mn) of 1.03×10⁴/mole as measured by GPC using polystyrene standards and a polydispersity index (Mw/Mn) of 1.15. This is designated Polymer 6.

### APPLICATION EXAMPLE

A resist solution was prepared by dissolving 3 g of each polymer obtained in Examples 4, 5 and 6, 0.12 g of triphenylsulfonium nonafluorobutanesulfonate (photoacid generator) and 0.006 g of tributylamine (basic quencher) in 25 ml of propylene glycol monomethyl ether acetate. The solution was filtered through a filter having a pore size of 0.2 μm. The resist solution was spin coated onto a silicon wafer having a 55-nm coating of DUV-30 (Brewer Science) formed thereon, and baked on a hot plate at 120° C. for 90 seconds to form a resist film of 300 nm thick.

Using an excimer laser stepper (Nikon Corporation, NSR-S203B, NA=0.68, σ=0.75, 2/3 annular illumination), the resist film was exposed to laser beams. The resist film was baked at 110° C. for 90 seconds immediately after exposure and developed with a 2.38% aqueous solution of tetramethylammonium hydroxide for 60 seconds. There was obtained a positive pattern having a resolution of 0.13 μm and a line to space ratio of 1:1.

Japanese Patent Application No. 2002-222955 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A fluorinated polymer obtained by living anion polymerization of a monomer having the general formula (1): 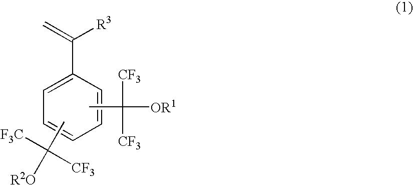
wherein R¹ and R² each are an acid labile group and R³ is hydrogen or methyl, and having a polydispersity index of 1 to 1.20.

2. The fluorinated polymer of claim 1 wherein the monomer has the general formula (2): 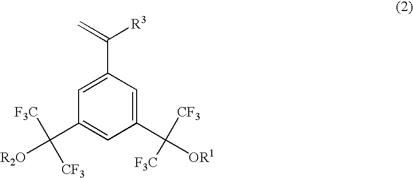
wherein R¹ and R² each are an acid labile group and R³ is hydrogen or methyl.
